(19) United States
(12) Patent Application Publication
(10) Pub. No.: US 2004/0146185 A1
(43) Pub. Date: Jul. 29, 2004

(54) Apparatus, system, and method for creating an electronic description of a geographic site

(76) Inventors: Forrest K. Blair, Hyde Park, UT (US); Matthew D. Cupal, Bountiful, UT (US)

Correspondence Address: KUNZLER & ASSOCIATES, 8 EAST BROADWAY, SALT LAKE CITY, UT, 84111, US

(21) Appl. No.: 10/713,783

(22) Filed: Nov. 14, 2003

Related U.S. Application Data
(60) Provisional application No. 60/426,201, filed on Nov. 14, 2002.

(51) Int. Cl. G06K 9/00; G06K 9/48

(52) U.S. Cl. 382/113; 382/198

(57) ABSTRACT

An apparatus, system, and method are disclosed for creating an electronic description of a geographic site. The apparatus, system, and method beneficially facilitate rapid capture, digitization, and creation of the electronic descriptions, which are advantageously smaller in storage size and widely distributed among users. The apparatus for creating an electronic description of a geographic site includes an electronic drafting program, a digitization module, and a capture module. The electronic drafting program is configured to import an image file, the image file comprising a plurality of image elements, and to electronically trace at least one of the image elements, which creates a tracing element. The digitization module is configured to associate definition data with the image element. The definition data is descriptive of the image element. Subsequently, the capture module stores at least the tracing element and corresponding definition data in a capture file. The capture file may be converted to a user file, including a compressed user file, and distributed to a user, such as via a wireless network.

### CROSS-REFERENCES TO RELATED APPLICATIONS

This application is a continuation-in-part of and claims priority to U.S. Provisional Patent Application No. 60/426,201 entitled “Method of Collection, Compression, Storage, and Display of Golf Course Data” and filed on Nov. 14, 2002 for Forrest K. Blair of Hyde Park, Utah, and Matthew D. Cupal of Providence, Utah, which is incorporated herein by reference.

### BACKGROUND OF THE INVENTION

1. Field of the Invention

This invention relates to electronic images and more particularly relates to creating, storing, distributing, and communicating an electronic description of a geographic site.

2. Description of the Related Art

The golfing industry has grown substantially over recent years and is currently a multi-billion dollar industry with tens of millions of recreational and professional golfers worldwide. Much of the recent increase in participation in the sport may be due to many technological advances in golfing equipment and accessories, as well as the rise of well-known professional golfers.

One of the golfing accessory lines that is increasing in popularity may be referred to as golf knowledge assistants, personal golfing assistants, course management systems, and so forth. These electronic golfing aids may be roughly categorized as handheld devices, cart-based devices, global positioning system (GPS) devices, and scorekeeping devices. While many of these systems have overlapping functionality and design elements, there are some common trends that pervade conventional electronic golfing aids.

Conventional handheld devices generally include software programs that may be loaded onto a personal digital assistant (PDA), such as a Palm or Pocket PC. These handheld devices allow a user to manipulate the golfing software in a variety of manners, including stylus input on a touch screen and multi-button controls. Many of these PDAs accept peripheral devices, such as a GPS card, via a peripheral port. In this way, the golfing software may interface with the GPS to show approximate user location, possibly on a digitized map of the golf course.

Another type of handheld device is a stand-alone product that does not require a PDA or additional hardware. Stand-alone, handheld devices often come in a design similar to that of a typical pager with alphanumeric output (no digital images). Other stand-alone products are often similar in functionality to these pager-like products, possibly having GPS technology, distance-finding technology, and scorekeeping capability. A user generally controls a standalone handheld device via multiple physical buttons.

Conventional cart-based devices are similar to handheld devices in many respects, except that the cart-based devices are meant to stay with the cart at the golf course, generally not with the player. These cart-based devices may show a perspective view of each hole, have GPS and distance-finding technology, and offer course management services to the golfing facility. For example, many of these cart-based systems allow course marshals to track the play of each party (assuming the players are using a cart), allow users to request food and beverage items from the clubhouse, track scores, and receive generalized tips on how to play each hole.

The user interface of a typical cart-based device includes a graphical display screen and multiple buttons for user input. These cart-based devices are usually sold directly to a golf course, rather than to the players, because of their design emphasis on golf course management and increased facility revenues. In fact, many of these cart-based devices are not designed to be carried around by a player, but instead may be securely attached to a golf cart.

Conventional GPS devices may be further described in two sub-categories: distance and mapping. However, many conventional GPS devices may incorporate both distance and mapping functionality in a single device. Many conventional GPS devices employ GPS and differential GPS technology to locate the players and/or carts. The location of the player may be pertinent to the player's game while the location of the carts and players may be important for efficient golf course management.

With regard to the mapping GPS devices, these devices often display a map of the course or specific hole and may track and display the location of the golfer in relation to the map. In other words, these devices locate the player within the course field of play as might be seen on a map or from an aerial perspective. Unfortunately, many of the maps used in these devices are devoid of important details. Although partially representative of the actual course layout, conventional maps are displayed on conventional GPS devices are more akin to lower resolution approximations than to accurate, detailed maps. In fact, these maps often do not provide much more information, if any, than is provided by the course illustration on a typical printed scorecard. The quality of the maps, of course, lies in the process used to generate the maps, as well as the techniques used to compress, store, distribute, and display the maps.

Conventional scorekeeping devices are possibly the most prevalent electronic golfing aids available. A majority of the conventional devices described above incorporate some type of scorekeeping capability. In addition, there are numerous stand-alone devices dedicated only to keeping score. These dedicated devices are typically much less expensive and allow user control via multiple buttons, including numeric buttons, and may have a graphical or alphanumeric display.

Generally, these conventional devices in their many forms suffer from multiple disadvantages, some of which have been mentioned above. Other disadvantages of these conventional devices include low quality maps lacking course details, large map file size that prohibits easy and widespread distribution of such maps, and complicated user interfaces. Additionally, as briefly described above, the process by which course maps, or the equivalent, are generated is generally cumbersome, time-consuming, and extremely expensive. At least one conventional device, in fact, requires a user to physically walk the course, marking tee boxes, center of greens, etc., for each hole.

What are needed are an apparatus, system, and method for creating, storing, distributing, and communicating an electronic description of a geographic site that overcomes many, if not all, of these disadvantages. Beneficially, such an apparatus, system, and method would decrease the time, expense, and complexity of mapping a course, facilitate distribution of such maps, increase the ease of user control of a handheld device, and provide additional features that facilitate tracking play as well as enhancing player performance.

### SUMMARY OF THE INVENTION

The present invention has been developed in response to the present state of the art, and in particular, in response to the problems and needs in the art that have not yet been fully solved by currently available electronic golf aids. Accordingly, the present invention has been developed to provide a process, apparatus, and system for creating, storing, distributing, and communicating an electronic description of a geographic site that overcome many or all of the above-discussed shortcomings in the art.

The apparatus for creating, storing, distributing, and communicating an electronic description of a geographic site is provided with a logic unit containing a plurality of modules configured to functionally execute the necessary steps of creating, storing, distributing, and communicating an electronic description of a geographic site. These modules in the described embodiments include an electronic drafting program, a digitization module, and a capture module.

The apparatus, in one embodiment, is configured to facilitate the creation of a capture file from an image file. The capture file ultimately may be converted to a user file by a graphical processing module. The digitization module may include a definition module, and identification module, a key reference module, and a rendering module. The definition module may be configured to access the definition data from a definition data file or source. The identification module may be configured to identify each of the image elements within the image file. The key reference module may be configured to identify a key reference element within the image file. The rendering module may be configured to create a rendering policy that describes the rendering procedure to be employed to render a tracing element and the capture file or user file.

The graphical processing module, in one embodiment, is configured to access the capture file and convert the capture file to a user file. The user file may be a print file, a compressed user file, a library database entry, a graphic file, or another similar file type. The graphical processing module may include a communication module, a parse module, an offset module, a compression module, a print module, a library database module, a compressed user file module, and a graphic module. The communication module may be configured to communicate a representation of the user file to a user via a user interface device. The offset module may be configured to calculate an element offset. The element offset may be a relative distance from the tracing element to a key reference element or to another tracing element.

The parse module may be configured to parse the tracing element and to discard one or more non-critical data points. In one embodiment, the parse module may identifying a best fit curve to approximate the tracing image and then discard any data points that are not required to describe the best fit curve. The compression module may be configured to compress the user file and to create a compressed user file.

The user interface apparatus, in one embodiment, is configured to communicate a user file to a user, such as in graphical format. The user interface apparatus may include a file update module, a menu navigation module, a tracking module, a prediction module, a distance module, and a selector. The file update module may be configured to communicate with a distribution server via the wireless communication network and to receive a user update file to update the user file.

The menu navigation module may be configured to create and display a hierarchical menu. The selector may be configured to allow a user to navigate the menu, make menu selections, and otherwise control the user interface apparatus. In one embodiment, the selector may have both rotational control and depressive control so that the user may either rotate a dial or depress the dial (like a button), allowing single-finger control.

The tracking module may be configured to track user locations and playing statistics, including scores, distances, rates, and so forth. The prediction module may be configured to offer predictive parameters to a user, including club selection for a particular hole or distance. The distance module may be configured to display a control point and at least one distance marker on the user interface apparatus. In one embodiment, the distance module may allow the user to adjust the distance marker on the user interface apparatus, and to calculate a distance between the control point and the distance marker. The distance marker, in one embodiment, may be an arcuate line displayed on the user interface apparatus.

A system of the present invention is also presented for creating, storing distributing, and communicating an electronic description of a geographic site. A method of the present invention is also presented for creating, storing, distributing, and communicating an electronic description of a geographic site. The method, in the disclosed embodiments, substantially includes the steps necessary to carry out the functions presented above with respect to the operation of the described apparatus and system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating multiple conventional electronic representations of geographical sites;

FIG. 2 is a schematic block diagram illustrating one embodiment of a capture system in accordance with the present invention;

FIG. 3 is a schematic block diagram illustrating one embodiment of a digitization module in accordance with the present invention;

FIG. 4 is a schematic diagram illustrating one embodiment of a graphical interface for a digitization module in accordance with the present invention;

FIG. 5 is a schematic block diagram illustrating one embodiment of a graphical processing module in accordance with the present invention;

FIG. 6 is a schematic block diagram illustrating one embodiment of a distribution system in accordance with the present invention;

FIG. 7a is a schematic diagram illustrating one embodiment of a user interface apparatus in accordance with the present invention;

FIG. 7b is a schematic diagram illustrating another embodiment of a user interface apparatus in accordance with the present invention;

FIG. 8 is a schematic block diagram illustrating one embodiment of a user interface apparatus in accordance with the present invention;

FIG. 9 is a schematic flow chart diagram illustrating one embodiment of an image capture method in accordance with the present invention;

FIGS. 10-11 are a schematic flow chart diagram illustrating one embodiment of a digitization method in accordance with the present invention;

FIG. 12 is a schematic flow chart diagram illustrating one embodiment of an image processing method in accordance with the present invention; and

FIG. 13 is a schematic flow chart diagram illustrating one embodiment of a user file method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

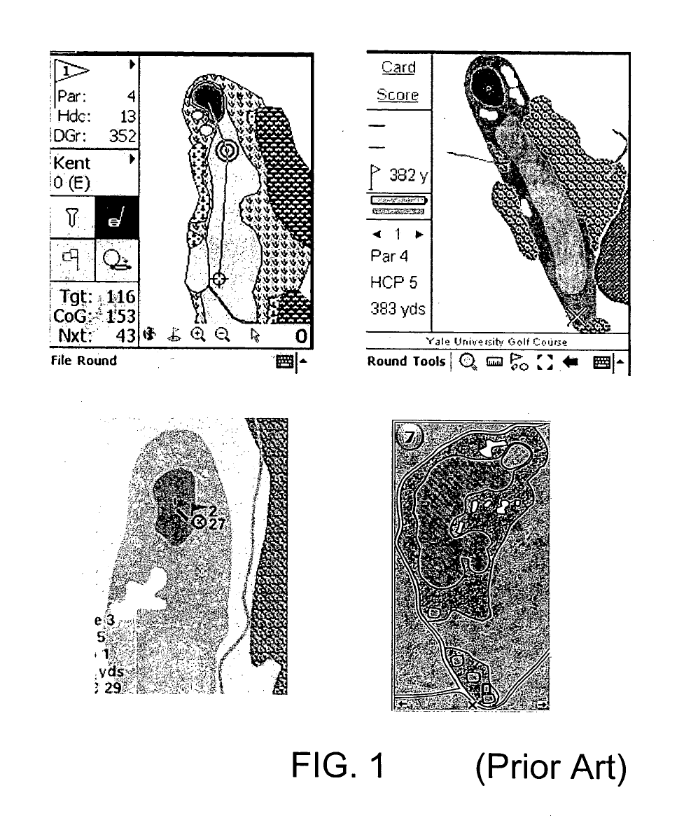

FIG. 1 depicts multiple conventional electronic representations of various geographical sites. Specifically, FIG. 1 depicts graphical representations of golf course holes. The graphical representations are typical of conventional handheld and portable golfing devices. As can be seen, the graphical images are rudimentary and lack significant details. In a golfing scenario, for example, these graphical representations do not show much detail in the way of trees, water hazards, cart paths

Except for some minor variations in shading and patterning, the depicted holes show only some of the major course elements, such as greens, fairways, tee boxes, and sand traps. Small hazards are not shown. Likewise, trees are only represented by a particular pattern and shading—they are not shown individually. While some of the conventional representations show cart paths, others do not. It is apparent that even despite some of the disparities among various conventional, graphical representations, the amount of detail depicted is severely restricted.

This presents a particular concern in a game such as golf, for instance, because the golfer has good reason to know the details of the course, rather than simply the general landscaping. It is critical that a golfer be aware of an isolated tree located just out of view past a dog leg to one side. Regardless of the general layout of the course or hole, perhaps the most important data to a golfer are the details affecting the next shot and lie. Similar needs for detailed geographic information are present in myriad other outdoor activities, including recreational, occupational, and emergency activities.

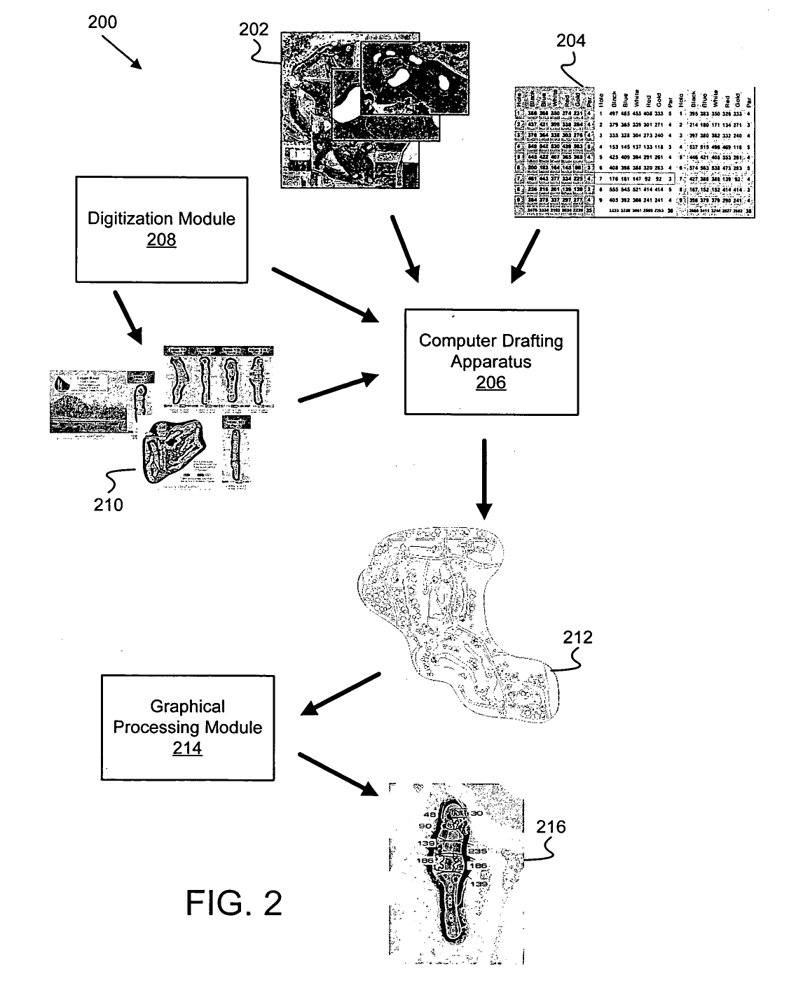

FIG. 2 depicts one embodiment of a capture system 200 that is configured to create an electronic description of a geographic site. Specifically, FIG. 2 outlines one embodiment of the logical flow of the input and output of the capture system 200. In particular, an image file 202 and definition data 204 are imported or otherwise input into a computer drafting apparatus 206. The computer drafting apparatus 206 may be a personal computer, workstation, or other computer device capable of running computer drafting software, such as AutoCad, DesignCad, or another similar computer drafting software program.

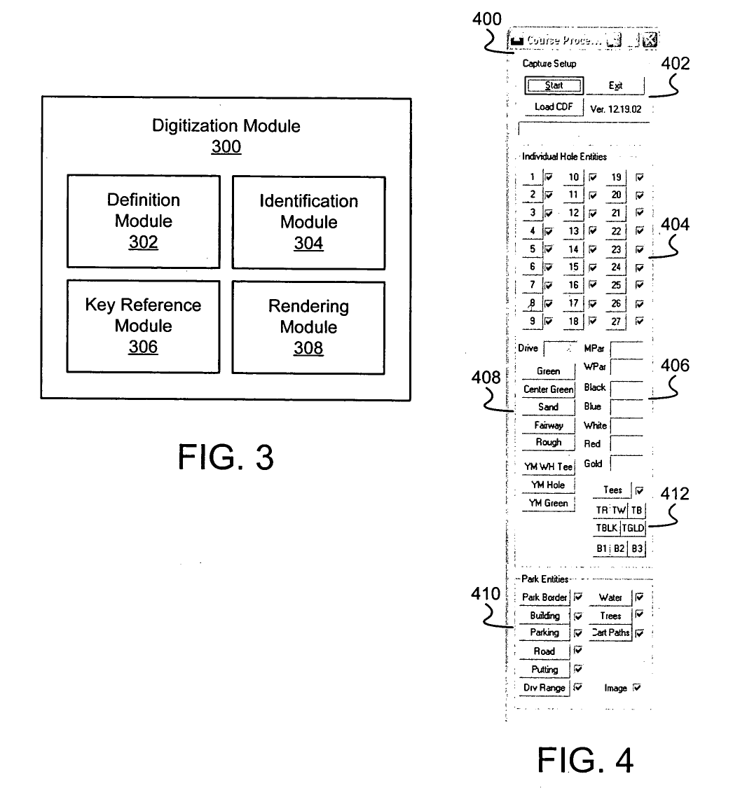

Using a digitization module 208, a user may create a representation of the geographic site with reference to the image file 202 and the definition data 204. The digitization module 208 will be described in more detail with reference to FIGS. 3 and 4. In one embodiment, the image file 202 may be an aerial photograph. In a further embodiment, the image file 202 may be a satellite photograph. Furthermore, the image file 202 may be a single file, multiple separate files, multiple files concatenated into a single file, or a selected portion of any of the foregoing files or combinations.

Furthermore, this description is not intended to limit the image file 202 to a substantially horizontal plane. Although not discussed in detail herein, it is appreciated that the image file 202 may include a representation of a substantially vertical or otherwise non-horizontal surface or surfaces. For instance, the image file 202 may depict the face of a rock wall, such as a rock climbing wall. It is also appreciated that the image file 202 and the capture system 200 may facilitate creating a digital representation of other, non-geographic sites and surfaces. Additionally, digital representations may be created of geographical and non-geographical sites and objects of varying sizes and dimensions.

The definition data 204, in one embodiment, may be golf course data, such as par, distance, and so forth, from a golf course scorecard. In another embodiment, the aerial photographs 202 may depict a national park and the definition data 204 may comprise trail distances, elevation rises, and so forth. In a further embodiment, the image file 202 may depict an aerial photograph of a recreational body of water, such as a lake or reservoir. In this example, the definition data may include buoy locations, beaches, water depths, and so forth. As these examples illustrate, the description of the logical capture system 200 is adequate to incorporate a variety of geographic sites and uses, as well as non-geographic sites and uses.

To aid in the creation of the electronic description or representation of the geographical site, a user or the digitization module 208 may refer to a reference image 210. For example, a user may refer to an illustrated map of a golf course to aid in identifying important elements within the image file 202.

By way of the digitization module 208 and the computer drafting apparatus 206, a user may create tracing elements from the image elements within the image file 202. The user also may assign some or all of the definition data 204 to the various tracing elements. In one embodiment, the tracing elements may be created by drawing lines on top of the image elements deemed to be important. A tracing policy may define a desired line width, type, color, etc. for each type of image element present in the image file 202. The resulting capture file 212 includes the tracing elements and the corresponding definition data 204. In a further embodiment, the capture file 212 also may include a representation of the image file 202 or portion thereof.

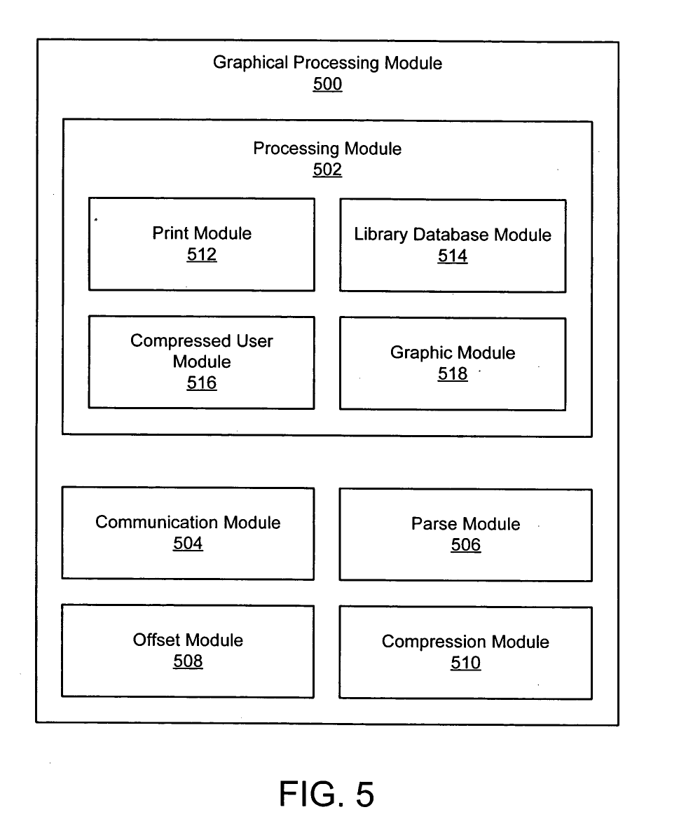

A graphical processing module 214 subsequently converts the capture file 212 to a user file 216. The graphical processing module 214 will be discussed in more detail with reference to FIG. 5. The user file 216 may be an electronic file that is configured to be displayed or otherwise communicated to a user. For example the user file 216 may be a print file for printing a graphic or text. Alternately, the user file 216 may be a graphic file for display on an electronic device, such as a computer terminal or a handheld electronic device. Furthermore, the user file 216 may be a database or database entry. In another embodiment, the user 216 may be a proprietary file type for output or display on a proprietary operating platform. Additionally, the user file 216 may be compressed or not compressed, such as using conventional or proprietary software compression techniques and programs.

FIG. 3 depicts one embodiment of a digitization module 300 that is substantially similar to the digitization module 208 of FIG. 2. The illustrated digitization module 300 includes a definition module 302, an identification module 304, a key reference module 306, and a rendering module 308. Other embodiments of the digitization module 300, of course, may have additional modules or fewer modules than the modules 302-308 described herein.

In one embodiment, the definition module 302 is configured to access the definition data 204 from a definition data file (not shown). For example, the scorecard data from a golf course scorecard may be input into a definition data file and stored in a database accessible by the digitization module 302. In another embodiment, the definition module 302 is configured to associate some or all of the definition data 204 with one or more tracing elements in the capture file.

The definition module 302, in a further embodiment, may be configured to associate at least some of the definition data 204 with a particular tracing element or elements within a capture file 212. The definition data 204 may be associated independently with a single tracing element or, alternately, may be associated with two or more tracing elements. For example, the definition module 302 may associate the distance of a golf course hole with both a tee box and a putting green. In another embodiment, the definition module 302 may associate a geographical elevation with a single tracing element, such as a lake shoreline or a mountain peak.

The identification module 304, in one embodiment, is configured to identify each of the tracing elements. For example, after the image elements in the image file 202 have been traced to create tracing elements, the identification module 304 may facilitate a user in designating each of the tracing elements as a primary, secondary, or tertiary tracing element. In one embodiment, a primary tracing element may be an element that is essential to the capture file 212, such as a putting green on a golf course hole. Similarly, a secondary tracing element may be an element that is non-critical to the capture file 212, such as an individual tree off of the fairway on a golf course hole. A cart path bridge or other object substantially outside of normal golf play may be designated as a tertiary tracing element. Alternately, the identification module 304 may be configured to identify all tracing elements within a capture file 212 as having equal importance, or, in a certain embodiment, identify tracing elements using more than three hierarchical levels.

The key reference module 306, in one embodiment, may be configured to identify a key reference element from the several tracing elements. The key reference element may serve as a relative reference point for some or all of the other tracing elements in a capture file 212. In one embodiment, the center of a putting green may serve as a key reference element for the other tracing elements related to a given golf course hole. When several golf course holes are included in a single capture file, the key reference module 306 may identify several key reference elements, for instance, one for each hole.

The rendering module 308, in one embodiment, may be configured to define a rendering policy that describes one or more rendering procedures to be employed when generating a user file 216. For example, the rendering module 308 may define a color, pattern, shading, or other representative characteristic for a given tracing element or set of tracing elements. In one embodiment, tertiary tracing elements of little importance to a given golf course hole may be depicted in a lighter shade than primary and secondary tracing elements.

FIG. 4 depicts one embodiment of a graphical digitization interface 400 for the digitization module 300 of FIG. 3. In one embodiment, the graphical digitization interface 400 may be loaded into the computer drafting apparatus 206 and operated within the computer drafting program environment. Alternately, the graphical digitization interface 400 may be a stand-alone application that acts independently from or in conjunction with the computer drafting apparatus 206.

The illustrated graphical digitization interface 400 includes, in one embodiment, one or more controls 402 that are configured to operate the digitization module 300 and the graphical digitization interface 400. The depicted graphical digitization interface 400 also includes a plurality of control selectors and user inputs. In one embodiment, the graphical digitization interface 400 may include one or more file segmentation controls 404 that identify independent or overlapping segments within the capture file 212. For example, the segmentation controls 404 may identify individual golf course holes within a capture file 212 that includes the entire course.

In the illustrated embodiment, the graphical digitization interface 400 also includes a plurality of text input controls 406. Each of the text input controls 406 may receive alpha-numeric input from a user, in one embodiment, or may be automatically filled in by the definition module 302 using the definition data 204.

The graphical digitization interface 400, in a further embodiment, also may comprise primary selectors 408 and secondary selectors 410 to indicate primary tracing elements and secondary tracing elements, respectively. By selecting one of the primary selectors 408 or secondary selectors 410, for example, the digitization module 300 may invoke a specified tracing profile that is particular to that primary or secondary tracing element. For instance, while tracing an image element, a user may select a primary selector 408, for instance, for a putting green. Upon selecting the primary selector 408 for the putting green, the digitization module 300 may operate with the computer drafting application 206 to select a pre-defined line width, color, style, and so forth, to be used to trace the corresponding putting green. The graphical digitization interface 400 may include other selectors 412 that otherwise facilitate tracing the image file 202 and creating the capture file 212.

FIG. 5 depicts one embodiment of a graphical processing module 500 that is substantially similar to the graphical processing module 214 of FIG. 2. In one embodiment, the graphical processing module 500 includes a processing module 502, a communication module 504, a parse module 506, an offset module 508, and a compression module 510. The processing module 502 further may comprise a print module 512, a library database module 514, a compressed user module 516, and a graphic module 518.

The processing module 502, in one embodiment, is configured to create a user file 216 in one or more user file formats. The communication module 504 is configured, in one embodiment to communicate the user file 216 to a user. In one embodiment, the communication module 504 may communicate the user file 216 to a handheld device, a printer, a database, or another similar user communication device.

The parse module 506, in one embodiment, is configured to parse each of the several tracing elements in the capture file 212. The parse module 506 also may be configured to approximate a best curve for a tracing element, identify non-critical data points within the tracing element, and discard the non-critical data points. In this way, each tracing element may be described by a minimal number of data points, thereby reducing the size of the resulting user file 216.

The offset module 508 also may be configured to reduce the size of the user file 216 by calculating relative offset distances for each of the tracing elements. Although the location of the various tracing elements each may be described by an absolute offset with reference to an absolute reference point, the user file 216 may be smaller in size if relative offsets are used instead of absolute offsets. An absolute offset for a tracing element may include a coordinate (x,y) offset from an absolute reference point (0,0), for instance, at one corner of the user file.

However, it may be substantially more efficient to use a relative offset for the tracing element. The relative offset may include a coordinate (x,y) offset from another tracing element, rather than from an absolute reference point. For example, the location of a tracing element representing a tree on a golf course may be described relative to another nearby tracing element. This relative offset approach may allow for smaller offset designations and may require less storage space in the user file 216. In alternate embodiments, the relative offset may be described using polar coordinates (r,θ), Cartesian coordinates (x,y), or another equivalent coordinate or referencing technique.

In one embodiment, the offset referencing may occur according to the hierarchical identification of a particular tracing element. For example, all key reference elements may use an absolute offset; all primary tracing elements may use a relative offset from the key reference; all secondary tracing elements may use a relative offset from any of the primary tracing elements; and all tertiary tracing elements may use a relative offset from any primary, secondary, or other tertiary tracing element. Of course, it is understood that many other offset referencing techniques may be employed without departing from the scope of the present invention.

The compression module 510, in one embodiment, may be configured to compress the resulting parsed tracing elements and offset data either prior to or subsequent to creating the user file 216. However, not all user files 216 are necessarily compressed. Some user files 216 may be created without any compression, depending on the user file format and the anticipated user interface device that will communicate the resulting user file 216 to a user.

As set forth above, the processing module 502 is configured to create a user file 216 that may be communicated to an end user. The print module 512 is configured, in one embodiment, to create a print file that may be sent to a printing device, such as a laser printer, for instance. The library database module 514, in one embodiment, is configured to create a database entry that may be stored in a database. The compressed user module 516, in one embodiment, may be configured to create a compressed user file 216 that is relatively small in size and easy to transmit across a potentially low bandwidth communication channel. In one embodiment, a compressed user file 216 for an entire golf course may be approximately 3 Kb in size. The graphic module 518, in one embodiment, may be configured to create a graphical user file 216 that may be displayed on a website, on a personal computer, or on other electronic device.

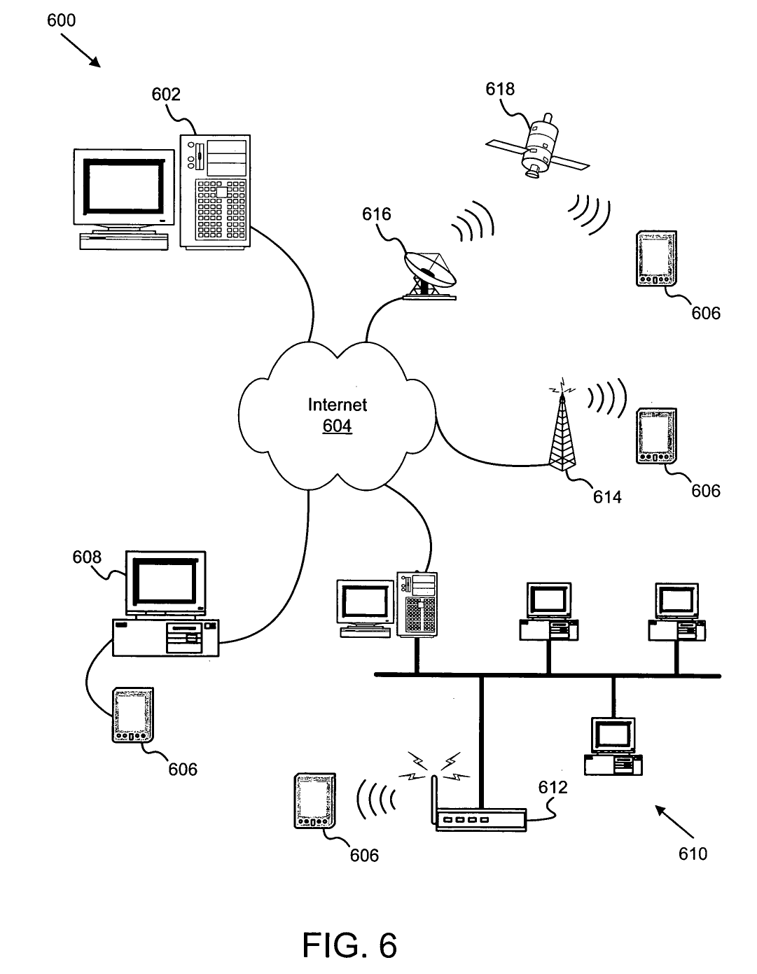

FIG. 6 depicts one embodiment of a distribution system 600 that may facilitate communication and distribution of a capture file 212 or a user file 216. The illustrated distribution system 600 includes a distribution server 602 connected to a communication network, such as the internet 604. The distribution server 602 may be configured to store a plurality of user files 216 that may be available in a variety of user file formats. The user files 216 may be requested by and sent to various user interface devices 606 connected to the distribution system 600.

In one embodiment, a user file 216 may be communicated to a user interface device 606 via a personal computer 608 connected to the internet 604 (intermediate equipment and connections are omitted for clarity). In another embodiment, a user file may be communicated to a network 610, such as a local area network (LAN) or similar network. The user file 216 subsequently may be communicated to a user interface apparatus 606 via a wireless transceiver 612, such as a wireless access point (WAP) using a wireless protocol, including IEEE 802.11b or 802.11g.

In a further embodiment, a user file 216 may be communicated to a cellular transceiver 614 for subsequent transmission to a user interface apparatus 606, such as a cellular telephone or other apparatus having adequate cellular capabilities. For example, a user file 216 may be transmitted to a cellular telephone using code-division multiple access (CDMA), time-division multiple access (TDMA), or another cellular transmission protocol. In an alternative embodiment, a user file 216 may be communicated to a user interface apparatus 606 using satellite technologies 616, 618. Additionally, the user interface apparatus 606 may interface with satellite technologies 616,618, such as a global positioning system (GPS) satellite, in order to properly locate the user interface apparatus 606 within a certain geographical site. The user interface apparatus 606 also may employ differential GPS (DGPS) techniques in order to improve accuracy of GPS measurements.

In a further embodiment, a user file 216 may be communicated to an end user who is not using a user interface device 606. For example, a user file 216 may be communicated to the personal computer 608 to be viewed on the personal computer 608, as in the case of a website graphic. It is understood that a user file 216 may be communicated to a variety of electronic equipment and user interface devices 606, including personal digital assistants (PDAs), cellular telephones, personal computers, onboard vehicular computers, an so forth.

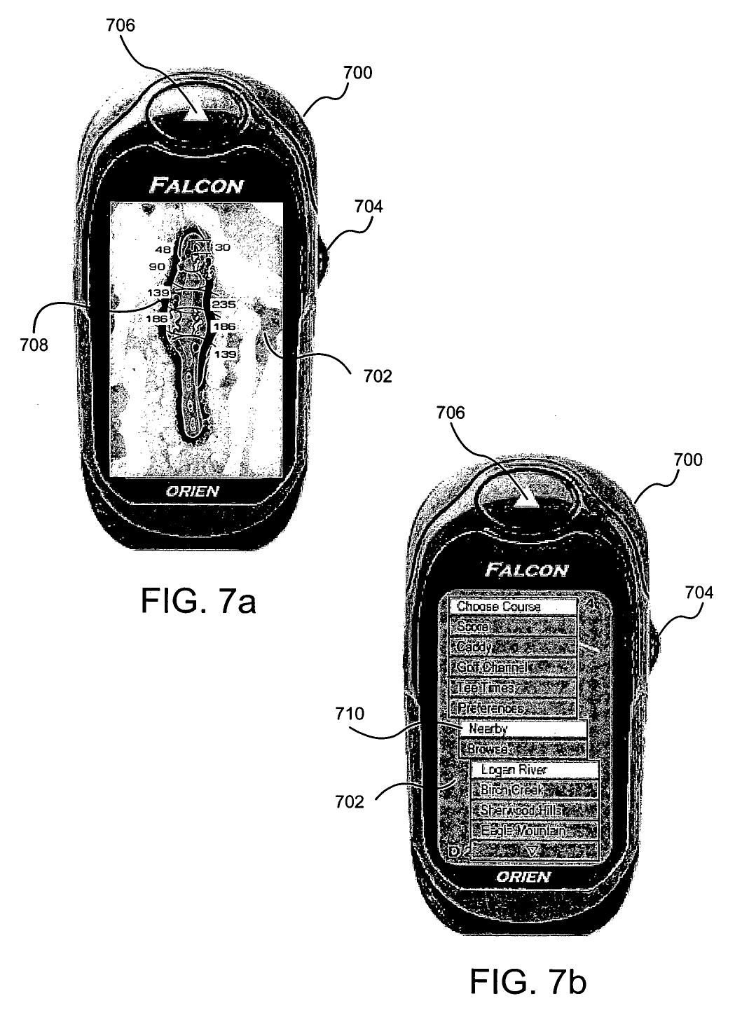

FIG. 7a depicts one embodiment of a user interface apparatus 700 that is substantially similar to one embodiment of the user interface apparatus 606 of FIG. 6. The illustrated user interface apparatus 700 includes a graphical display 702, a selector 704, and a directional indicator 706. The graphical display 702 may include an LCD screen that is capable of displaying still graphics or video graphics. The user interface apparatus 700 also may include other output devices, including LED indicators, a speaker, and so forth. In the depicted embodiment, the display 702 displays a graphic of a golf course hole. The depicted display 702 also overlays one or more distance markers 710 over the displayed graphic.

The selector 704 is configured to allow a user to control user input to the user interface apparatus 700. For example, the selector 704 may control the display 702. In a further embodiment, the selector 704 may control the distance marker 710. For example, a user may rotate the selector 704 in order to change the calculated distance the distance marker 710 and an origin, such as the location of the player, the pin, or another element. The user interface apparatus 700, in a further embodiment, may include additional user input controls in the form of buttons, touch screens, microphones, digital interfaces, and so forth.

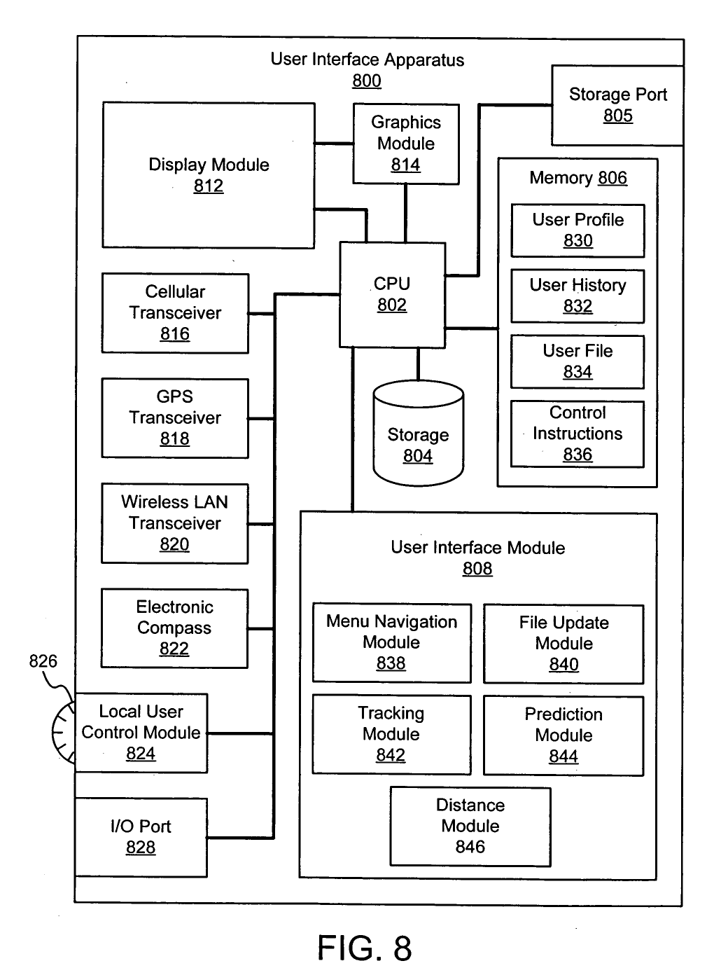

The directional indicator 706 is configured to indicate a relative direction and orientation of the user interface apparatus 700. The directional indicator 706 may be oriented in conjunction with an electronic compass within the user interface apparatus 700. The electronic compass is depicted and discussed in more detail with reference to FIG. 8.

FIG. 7b depicts another embodiment of the user interface apparatus 700. The user interface apparatus 700 of FIG. 7b displays a menu 710 on the display 702. In one embodiment, the menu 710 is a hierarchical menu 710 that is configured to be navigated and controlled exclusively by the selector 704. In this manner, for example, a user may navigate the hierarchical menu 710 by rotating the selector 704. The user may expand sub-folders within the hierarchal menu 710 either by depressing the selector 704 or by highlighting a menu item for a predetermined period of time, such as 2 seconds. The user may select a menu item, in one embodiment, by depressing the selector 704. With the selector 704 configured to allow a user to fully navigate the hierarchical menu 710, a user may control the user interface apparatus 700, for example, with a single finger.

FIG. 8 depicts a logical representation of a user interface apparatus 800 that is substantially similar to one embodiment of the user interface apparatus 606 of FIG. 6. The illustrated user interface apparatus 800 includes a central processing unit 802, an electronic storage device 804, a storage port 805, an electronic memory device 806, and a user interface module 808. The illustrated user interface apparatus 800 also includes a display module 812, a graphics module 814, a cellular transceiver 816, a GPS transceiver 818, a wireless LAN transceiver 820, an electronic compass 822, a local user control module 824, and an input/output (I/O) port 828.

The CPU 802 is configured generally to execute operations within the user interface apparatus 800. The storage port 805 is configured, in one embodiment, to accept data from an external storage source. An external storage source may comprise a magnetic disk, an electronic memory card, an optical storage medium, or another similar storage medium. In one embodiment, the storage port 805 may be configured to accept a flash memory card having at least one user file 216 stored thereon.

The local memory device 806 is configured, in one embodiment, to store several data and metadata files that may be used in conjunction with the operation and administration of a user file 216. In an alternative embodiment, some or all of these data and metadata files may be replicated in the electronic storage device 804. In a further embodiment, one or all of these data and metadata files may be stored exclusively in the electronic storage device 804 rather than in the electronic memory device 806. Similarly, these data and metadata files may be stored on a combination of local memory 806 and storage 804. Although the present description refers to “files,” the present invention is understood to operate in substantially the same manner using other electronic memory and storage structures. Reference herein to a data file or metadata file is understood to equivalently refer to other such electronic memory and storage structures.

In the illustrated embodiment, the local memory device 806 may store a user profile 830, a user history 832, a user file 834, and one or more control instructions 836. The user profile 830, in one embodiment, may comprise user preferences, a user name, a user-defined menu, network access codes, and other user-defined information specific to a particular user. The user history 832, in one embodiment, may be configured to store historical data pertinent to a given user. For example, the user history 832 may store golfing statistics for one or more rounds or golf. The user history 832 also may comprise location tracking statistics, file update statistics, and other pertinent historical information related to a user of to the user interface apparatus 800.

The user file 834, in one embodiment, is substantially similar to the user file 216 of FIG. 2. As described above, the user file 834 may comprise a print file, a graphic file, a compressed user file, a database, on another similar file. The control instructions 836, in one embodiment, may comprise control instructions associated with a specific user file 834, or with a specific computer application that accesses the user file 834. The control instructions 836 also may include operational instructions regarding defining the user profile 830, tracking the user history 832, connecting to external devices and networks, importing additional user files 834, and so forth.

In one embodiment, the menu navigation module 838 may be configured to facilitate user-navigation of a menu 710 on the user interface apparatus 800. The file update module 840, in one embodiment, may be configured to facilitate an update to a user file 834. In one embodiment, the tracking module 842 may be configured to store and update a user history 832. In one embodiment, the prediction module 844 may be configured to generate a predictive parameter based on the user history 832. For instance, the prediction module 844 may employ an algorithm to determine which golf club a golfer might use to hit a shot at hand. The prediction module 844 considers previous shots on the same course, previous shots on similar courses, shot distance, weather conditions, elevation rise to the next lie, potentially obstructive geographical elements, and so forth.

The distance module 846, in one embodiment, may be configured to calculate a distance between two tracing elements within the user file 834. For example, the distance module 846 may calculate a distance from the current location of the user interface apparatus 800 to the center of green or cup of a golf course hole. The distance module 846, in a further embodiment, also may facilitate displaying the distance marker 708 discussed with reference to FIG. 7a.

The display module 812 is configured, in one embodiment to display a user file 834, or portion thereof, and associated information to a user. The display module 812 also may be configured to display the hierarchical menu 710 discussed above. In one embodiment, the graphics module 814 is configured to process graphics for display on the display module 812.

The cellular transceiver 816 is configured to send and receive communication signals over a cellular network. Likewise, the global positioning system (GPS) transceiver is configured to send and receive communication signals over a GPS network. Similarly, the wireless LAN transceiver 820 is configured to send and receive communication signals over a wireless LAN network. The electronic compass 822, in one embodiment, is configured to determine a geographical orientation of the user interface apparatus 800. In a further embodiment, the distance module 846 may reference a user history 832 and the electronic compass 822 in order to estimate the location of a golf ball hit in a general direction with a probability of an estimated distance.

The local user control module 824, in one embodiment, is configured to allow a user to interact with the user interface apparatus 800, including allowing input data and other commands from a user and, in a further embodiment, communicating output data to the user. In a further embodiment, the local user control module 824 may comprise a selector 826, such as a scroll wheel, that affords the user both rotational and depressive control. The selector 826 may be substantially similar to the selector 704 of FIG. 7a.

In one embodiment, the user may turn the wheel or dial selector 826 to navigate, for instance, a hierarchical menu 710. Alternately, the user may depress the selector 826 to make a selection on the menu 710. Of course, a user may use the rotational and depressive functionality of the selector 826 to navigate and control many other aspects of a user file 834 or similar computer application. For example, the user may rotate the dial 826 in order to control the distance marker 708 and display a calculated distance.

The I/O port 828 is configured, in one embodiment, to facilitate network communications of the user interface apparatus 800 with another electronic device, such as a personal computer 608 or the distribution server 602. In one embodiment, the I/O port 828 is configured to accept a hardwire connection, such as an Ethernet or fiber optic connection.

The following schematic flow chart diagrams that follow are generally set forth as logical flow chart diagrams. As such, the depicted order and labeled steps are indicative of one embodiment of the presented process. Other steps and processes may be conceived that are equivalent in function, logic, or effect to one or more steps, or portions thereof, of the illustrated process. Additionally, the format and symbology employed are provided to explain the logical steps of the process and are understood not to limit the scope of the process. Although various arrow types and line types may be employed in the flow chart diagrams, they are understood not to limit the scope of the corresponding process. Indeed, some arrows or other connectors may be used to indicate only the logical flow of the process. For instance, an arrow may indicate a waiting or monitoring period of unspecified duration between enumerated steps of the depicted process. Additionally, the order in which a particular process occurs may or may not strictly adhere to the order of the corresponding steps shown.

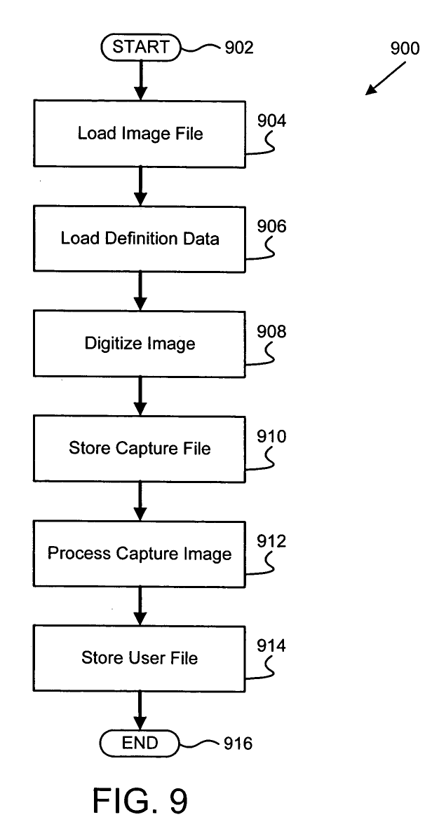

FIG. 9 depicts one embodiment of an image capture method 900. The illustrated image capture method 900 begins 902 by loading 904 an image file 202 into the computer drafting apparatus 206. The image file 202 may be loaded 904 automatically or in response to a user command. The image capture method 900 then loads 906 the necessary definition data 204 into the computer drafting apparatus 206. In one embodiment, a user may employ the digitization module 208 to load the definition data 204. The digitization data 204 may be entered manually, in certain embodiments, by a user using a keypad or selection boxes.

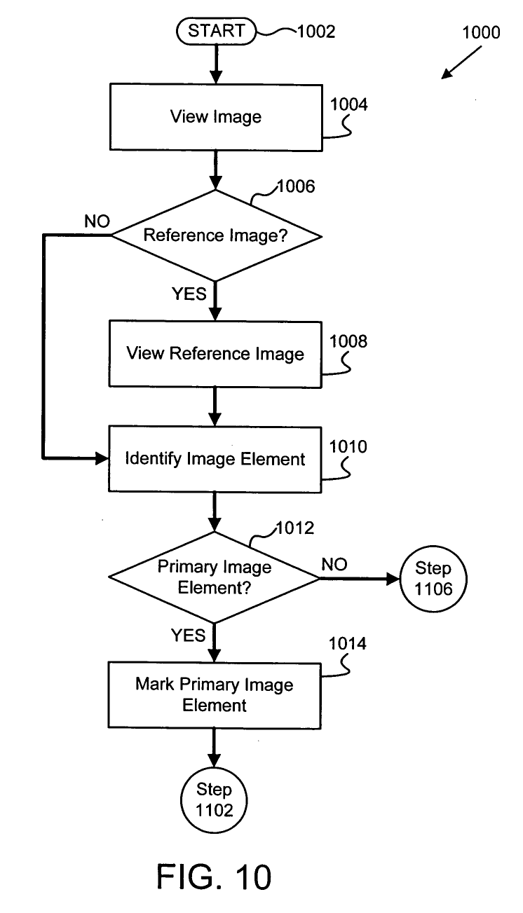

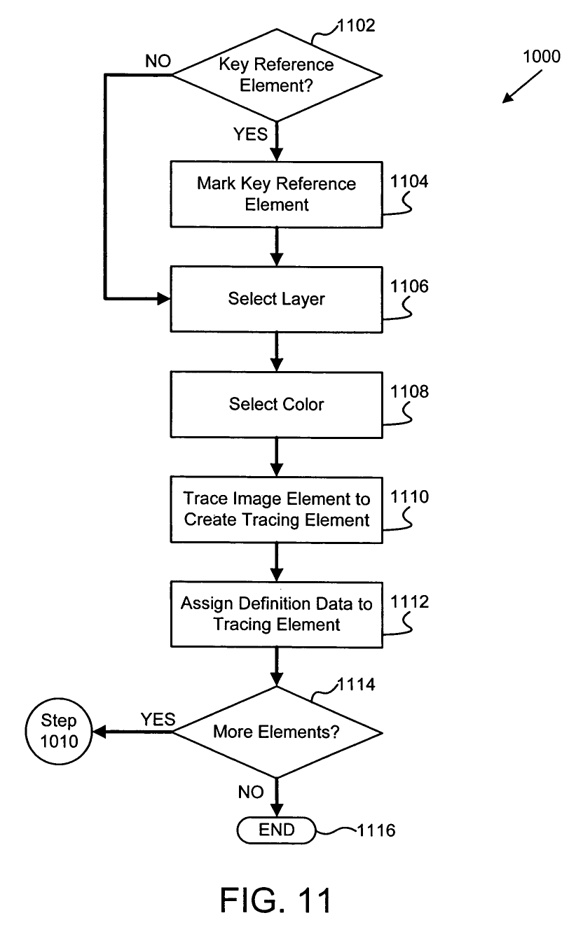

The image capture method 900 continues as the image elements of the image file 202 are digitized 908, for instance, by electronically tracing the image elements to create corresponding tracing elements. A method of digitizing 908 the image file 202 will be described in more detail with reference to FIGS. 10 and 11. The image capture method 900 then stores the resulting capture file 212. In one embodiment, a capture module (not shown) may be employed to store the capture file 212. In one embodiment, the capture module may be incorporated into either the computer drafting apparatus 206 or the digitization module 208.

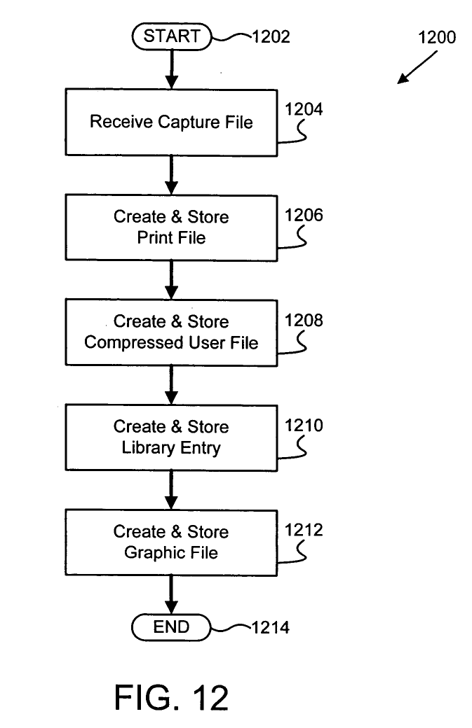

The graphical processing module 500 then processes 912 the capture file 212 and stores 914 the resulting user file 216. Processing 912 the capture file 212 will be described in more detail with reference to FIG. 12. The resulting user file 216 may be stored 914, in one embodiment, on the distribution server 602. The depicted image capture process 900 then ends 916.

FIGS. 10 and 11 depict one embodiment of a digitization method 1000 that is given by way of example of the digitization step 908 of the image capture process 900 of FIG. 9. The illustrated digitization method 1000 begins 1002 as a user views 1004 the image file 202 within the computer drafting apparatus 206. For example, the user may open the image file 202 and see a graphical representation of the image file 202 on a computer screen. If it is determined 1006 that there is a reference image 210 available for viewing, the user also may view 1008 the reference image 210 to clarify or further define an image element within the image file 202. For example, a user may view an illustration on a scorecard for a golf course in order to determine the exact placement of a tee box or putting green.

Using the image file 202 and the available reference image 210, if any, the user identifies 1010 the geographic image elements within the image file 202. The user may then determine 1012 if an image element is to be designated a primary element. If so, the user identifies 1014 the image element as a primary image element. In one embodiment, identifying 1014 the image element as a primary image element also identifies the corresponding tracing element as a primary tracing element. In a certain embodiment, the user may employ the digitization module 300 to identify 1014 the image element. If a certain image element is not identified 1014 as a primary image element, the image element may be automatically identified by the digitization module 300 as a secondary image element, for instance.

The user then may determine 1102 if the currently identified 1014 primary image element is a key reference element. If so, the user may identify 1104 the image element as a key reference element. In one embodiment, the user may employ the digitization module 300 to identify 1104 the key reference element. In a certain embodiment, identifying 1104 the image element as a key reference element also identifies the corresponding tracing element as a key reference element.

After determining 1012 if the image element is a primary image element and potentially determining 1102 if the image element is a key reference element, the illustrated digitization method 1000 continues as the user selects 1106 a tracing layer, selects 1108 a tracing color, and traces 1110 the image element to create a corresponding tracing element. In a further embodiment, the user may select additional tracing features, including line weight, line pattern, sub-layers, and so forth.

The user then assigns 1112 the appropriate definition data 204 to the newly created tracing element. In one embodiment, the user may employ the digitization module 300 to assign 1112 the definition data 204 to the tracing element. The digitization method 1000 then determines 1114 if additional image elements need to be traced and, if so, returns to identify 1010 the subsequent image element. In another embodiment, the user may assign some or all of the definition data 204 to the tracing elements after all of the tracing elements have been created. The depicted digitization method 1000 then ends 1116.

In a further embodiment, the user may identify an image element as a secondary, tertiary, or other type of image element. The present invention does not limit the user to only two or three hierarchical designations of image or tracing elements. Additionally, the image elements may be traced 1110 prior to being identified 1014, 1104 as a primary image element or key reference element.

FIG. 12 depicts one embodiment of an image processing method 1200 that may be employed by the graphical processing module 500. The illustrated image processing method 1200 begins 1202 as the graphical processing module 500 receives 1204 the capture file 212. In one embodiment, the capture file 212 may be received 1204 from the computer drafting apparatus 206 or the digitization module 208. Alternately, the capture file 212 may be received 1204 from the distribution server 602 or another computer.

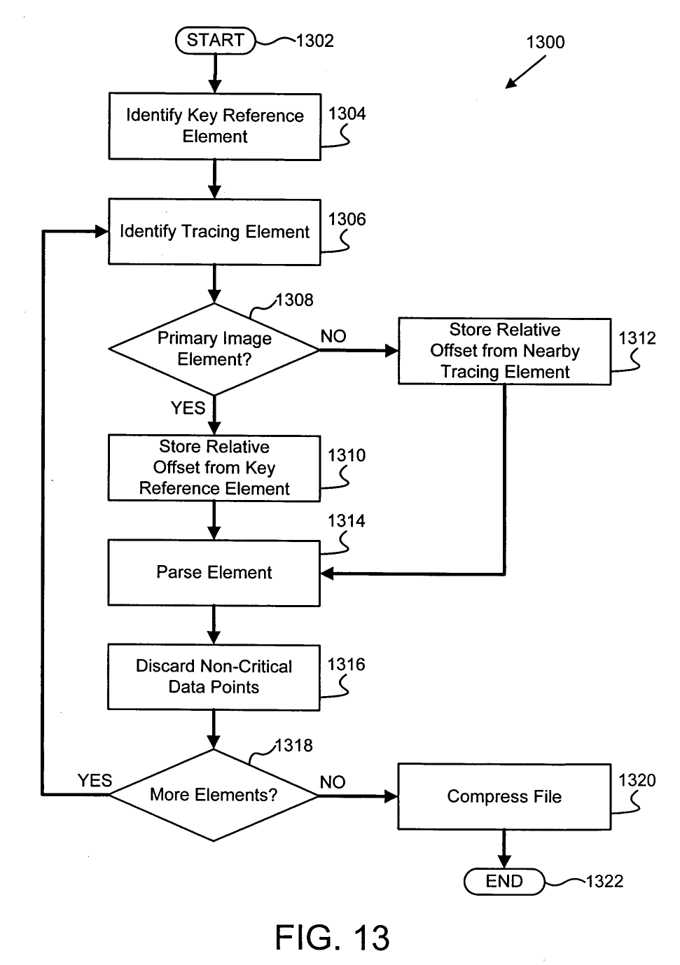

The graphical processing module 500 then may create and store 1206 a print file, create and store 1208 a compressed user file, create and store 1210 a library database entry, create and store 1212 a graphic file, or create and store another type of user file 216 that may be communicated to a user via, for example, a user interface apparatus 800. The depicted image processing method 1200 then ends 1214. The step of creating and storing 1208 a compressed user file will be discussed more with reference to FIG. 13.

FIG. 13 depicts one embodiment of a user file method 1200 given by way of example of the creation and store step 1208 of the image processing method 1200 of FIG. 12. The illustrated user file method 1200 may be employed by the graphical processing module 500 in order to create and store 1208 one type of compressed user file.

The user file method 1300 begins 1302 by identifying 1304 the key reference element within the capture file 212. The user file method 1300 then identifies 1306 a tracing element within the capture file 212. The graphical processing module 500 then may determine 1308 if the currently identified 1306 tracing element is a primary tracing element and, if so, may calculate and store 1310 a relative offset from the primary tracing element to the key reference element.

Otherwise, if the currently identified 1306 tracing element is not a primary tracing element, the graphical processing module 500 may calculate and store a relative offset from the non-primary tracing element to another nearby tracing element. In one embodiment, the nearby tracing element is the closest tracing element to the currently identified 1306 tracing element, thereby using a relatively small offset.

In a further embodiment, the graphical processing module 500 may employ the offset module 508 in order to calculate and store 1310, 1312 the relative offset for each tracing element. Additionally, in a certain embodiment, the offset may be calculated relative to any of the tracing elements depending on the identification and offset policies of the digitization module 300 and the graphical processing module 500. For example, the offset for each tracing element may be calculated differently depending on whether the tracing element is a key reference element, a primary tracing element, a secondary tracing element, a tertiary tracing element, and so forth, as described above.

The depicted user file method 1300 then continues as the graphical processing module 500 parses 1314 the tracing element and discards 1316 one or more non-critical data points. As explained previously, the parse module 506 may employ a best fit curve approximation in order to determine which data points are non-critical to the tracing element. After processing a tracing element, the graphical processing module 500 determines 1318 if additional tracing elements need to be processed and, if so, returns to identify 1306 a subsequent tracing element.

After all of the tracing elements have been processed, the graphical processing module 500 then may compress 1320 the tracing elements and associated definition data 204 to create a compressed user file. In one embodiment, the graphical processing module 500 may employ the compression module 510 to compress the tracing elements and associated definition data 204. The illustrated user file method 1300 then ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for creating an electronic description of a geographic site, the apparatus comprising:
an electronic drafting program configured to import an image file, the image file comprising a plurality of image elements, and to electronically trace at least one of the image elements, creating a tracing element;
a digitization module configured to associate definition data with the image element, the definition data at least partially descriptive of the image element; and
a capture module configured to store the tracing element and the definition data in a capture file, the capture module within one of the electronic drafting program and the digitization module.

2. The apparatus of claim 1, wherein the digitization module further comprises a definition module configured to access the definition data from a definition data file.

3. The apparatus of claim 1, wherein the digitization module further comprises an identification module configured to identify each of the plurality of image elements as one of a primary image element, a secondary image element, or a tertiary image element.

4. The apparatus of claim 3, wherein the digitization module further comprises a key reference module configured to identify a key reference element, the key reference element selected from one of the primary image elements.

5. The apparatus of claim 1, wherein the image element is a primary image element and the tracing image is a primary tracing image.

6. The apparatus of claim 1, wherein the image element is a secondary image element and the tracing image is a secondary tracing image.

7. The apparatus of claim 1, wherein the image file represents a composite satellite photograph of a golf course and the definition data comprises at least one of a hole number, a hole par, and a hole distance.

8. The apparatus of claim 1, wherein the image element represents one of a tee box, a fairway, a putting green, a cup, a sand trap, a water hazard, a tree, a building, a road, and a cart path.

9. The apparatus of claim 1, further comprising a rendering module configured to create a rendering policy, the rendering policy descriptive of the rendering procedure employed to render the tracing element.

10. The apparatus of claim 1, further comprising a graphical processing module configured to access the capture file and convert the capture file to a user file.

11. The apparatus of claim 10, wherein the user file is one of a print file, a compressed user file, a library database, and a graphic file.

12. The apparatus of claim 10, wherein the graphical processing module comprises a communication module communicate a representation of the user file to a user via a user interface device.

13. The apparatus of claim 10, wherein the graphical processing module comprises an offset module, the offset module configured to calculate an element offset, the element offset relative from the tracing element to a key reference element.

14. The apparatus of claim 10, wherein the graphical processing module comprises an offset module, the offset module configured to calculate an element offset, the element offset relative from the tracing element to another tracing element.

15. The apparatus of claim 10, wherein the graphical processing module is further configured to associate an element offset with the tracing element and to store the tracing element and the element offset in the user file.

16. The apparatus of claim 10, wherein the graphical processing module comprises a parse module, the parse module configure to parse the tracing element and to discard a non-critical data point, wherein discarding a non-critical data point comprises identifying a best fit curve to approximate the tracing image and discarding a data point that is not required to describe the best fit curve.

17. The apparatus of claim 10, wherein the graphical processing module comprises a compression module, the compression module configured to compress the user file and to create a compressed user file.

18. A system for communicating an electronic description of a geographic site, the system comprising:
a wireless communication network;
a distribution server configured to store one or more user files; and
a user interface apparatus configured to communicate with the distribution server via the wireless communication network and to receive the one or more compressed user files, the compressed user files corresponding to the user files on the distribution server and descriptive of a geographic site.

19. The system of claim 18, wherein the user interface apparatus comprises a file update module, the file update module configured to communicate with the distribution server via the wireless communication network and to receive a user update file to update the user file.

20. The system of claim 18, wherein the user interface apparatus comprises a menu navigation module, the menu navigation module configured to create and display a hierarchical menu, the menu configured to facilitate user navigation and selection using a selector having both rotational and depressive control.

21. The system of claim 18, wherein the user interface apparatus comprises a selector, the selector having both rotational control and depressive control, the selector configured to allow a user to manipulate the user interface apparatus, including menu navigation, menu selection, graphical display, and user input, using a single hand.

22. The system of claim 18, wherein the user interface apparatus comprises a distance module, the distance module configured to display a control point and at least one distance marker graphically represented on the user interface apparatus, to allow a user to adjust the distance marker on the user interface apparatus, and to calculate a distance between the control point and the distance marker.

23. The system of claim 22, wherein the distance marker is an arcuate line having an origin at the control point and having an adjustable arc length.

24. A computer readable storage medium comprising computer readable code configured to carry out a method for creating an electronic description of a geographic site, the method comprising:
importing an image file, the image file having a plurality of image elements;
electronically tracing at least one of the image elements, creating a tracing element;
associating definition data with the image element, the definition data at least partially descriptive of the image element; and
storing the tracing element and the definition data in a capture file.

25. The computer readable storage medium of claim 24, wherein the method further comprises identifying the plurality of image elements and categorizing each of the plurality of image elements as one of a primary image element, a secondary image element, or a tertiary image element.

26. The computer readable storage medium of claim 24, wherein the method further comprises associating an element offset with the tracing element and storing the tracing element and the element offset in a user file, the element offset representing a distance between the tracing element and one of a key element or another tracing element.

27. The computer readable storage medium of claim 24, wherein the method further comprises parsing the tracing element and discarding a non-critical data point, wherein discarding a non-critical data point comprises identifying a best fit curve to approximate the tracing image and discarding a data point that is not required to describe the best fit curve.

28. The computer readable storage medium of claim 24, wherein the method further comprises creating a user file from the capture file, compressing the user file, and communicating the user file from a distribution server to a user interface apparatus via a wireless communication channel.

29. The computer readable storage medium of claim 24, wherein the method further comprises displaying a representation of the user file on the user interface apparatus and facilitating user navigation of a hierarchical menu and selection of menu items using a selector having both rotational and depressive control, the selector configured to allow a user to manipulate the user interface apparatus, including menu navigation, menu selection, graphical display, and user input, using a single hand.

30. A method for communicating an electronic description of a geographic site, the process comprising:
importing an image file, the image file having a plurality of image elements;
accessing a plurality of definition data, the definition data at least partially descriptive of the image elements in the image file;
identifying the plurality of image elements and categorizing each of the plurality of image elements as one of a primary image element, a secondary image element, or a tertiary image element;
identifying a key reference element, the key reference element selected from one of the primary image elements;
electronically tracing each of the primary image elements to create a corresponding primary tracing element;
electronically tracing each of the secondary image elements to create a corresponding secondary tracing element;
associating a portion of the definition data with at least one of the tracing elements;
storing the tracing elements and associated definition data in a capture file;
accessing a capture file, the capture file comprising a key reference element and at least one primary tracing element;
identifying the key reference element, the key reference element having a key reference offset from a known capture file reference;
identifying the primary tracing element;
calculating an element offset, the element offset relative from the primary tracing element to the key reference element;
associating the element offset with the primary tracing element;
parsing the primary tracing element and discarding a non-critical data point;
wherein discarding comprises identifying a best fit curve to approximate the tracing image and discarding a data element that is not required to describe the best fit curve;
storing the key reference element, the parsed primary tracing element, and the element offset in a user file;
compressing the user file to create a compressed user file;
distributing a compressed user file to a user, the compressed user file from a distribution server to a user interface apparatus via a wireless communication channel;
distributing a user update file to the user at a point of sale via a wireless communication channel;
